(19) United States
(12) Patent Application Publication
(10) Pub. No.: US 2022/0318644 A1
(43) Pub. Date: Oct. 6, 2022

(54) PRIVACY PRESERVING MACHINE LEARNING PREDICTIONS

(71) Applicant: Google LLC, Mountain View, CA (US)

(72) Inventors: Wei Huang, Kirkland, WA (US); Joshua Patrick Gardner, Seattle, WA (US); Michael William Daub, Woodinville, WA (US); Alexander E. Mayorov, Kirkland, WA (US)

(21) Appl. No.: 17/608,221

(22) PCT Filed: Oct. 14, 2020
(86) PCT No.: PCT/US2020/055525

§ 371 Date: Nov. 2, 2021

(51) Int. Cl. G06N 5/02

(52) U.S. Cl. CPC G06N 5/022

(57) ABSTRACT

Methods, systems, and apparatus, including computer programs encoded on a computer storage medium, for providing digital components to a client device. Methods can include assigning a temporary group identifier to a client device that identifies a particular group, from among a plurality different groups, that includes the client device based on a current period of user activity on the client device. A training set is generated for training a machine learning model that generates user characteristics. A request for digital component is received from the client device that includes the temporary group identifier currently assigned to the client device, a subset of activity features and one or more additional features that are based on the client device. The machine learning model generates one or more user characteristics based on which one or more digital components are selected and transmitted to the client device.

### BACKGROUND

This specification relates to data processing and machine learning models.

A client device can use an application (e.g., a web browser, a native application) to access a content platform (e.g., a search platform, a social media platform, or another platform that hosts content). The content platform can display, within an application launched on the client device, digital components (a discrete unit of digital content or digital information such as, e.g., a video clip, an audio clip, a multimedia clip, an image, text, or another unit of content) that may be provided by one or more content source/platform.

### SUMMARY

In general, one innovative aspect of the subject matter described in this specification can be embodied in methods including the operations of assigning, to a client device, a temporary group identifier that identifies a particular group, from among a plurality different groups, that includes the client device based on a current period of user activity on the client device; generating, for a model to be trained, a training set including (i) a temporary group identifier assigned to the client device based on a current period of user activity at a client device, (ii) a set of group features of users that have been assigned the temporary group identifier, and (iii) a set of activity features of user activity performed by users that have been assigned the temporary group identifier, wherein the temporary group identifier identifies a particular group, from among a plurality of different groups, that includes the client device; training the model using the training set; receiving, from a given client device, a request for a digital component, the request including at least: (i) the temporary group identifier that is currently assigned to the given client device, (ii) a subset of the set of activity features and (iii) one or more additional features wherein the one or more additional features are based on the client device; generating, by applying the trained model to (i) the temporary group identifier and (ii) the subset of the activity features included in the request, one or more user characteristics that are not included in the request; selecting one or more digital components based on the one or more user characteristics generated by the trained model; and transmitting, to the client device, the selected one or more digital components.

Other implementations of this aspect include corresponding apparatus, systems, and computer programs, configured to perform the aspects of the methods, encoded on computer storage devices. These and other implementations can each optionally include one or more of the following features.

In some aspects, the set of group features includes: (i) a plurality of uniform resource locators (URLs) that includes a plurality of URLs accessed by users that have been assigned the temporary group identifier, (ii) a representation of the plurality of URLs accessed by users that have been assigned the temporary group identifier. In some aspects, the set of group features may further include: (i) a count and/or proportions of the URLs accessed by users that have been assigned the temporary group identifier, (ii) patterns in digital content presented at the URLs accessed by users that have been assigned the temporary group identifier.

In some aspects, the set of group features includes one or more aggregate user group demographics collectively characterizing the users in the particular group corresponding to the temporary group identifier without characterizing any individual user in the particular group. In some aspects, the set of group features includes an aggregate context prediction, wherein the aggregate context prediction is a predicted output based on the digital content accessed by users that have been assigned the temporary group identifier.

In some aspects, each sample of the training set includes at least: (i) an anonymized identifier of a user that has been assigned the temporary group identifier, (ii) URLs accessed by the user while the user was assigned the temporary group identifier.

In some aspects, the set of activity features includes: (i) a geographic identifier specifying an origin of the request for the digital component, (ii) a time at the origin when the request for the digital component was submitted.

Particular embodiments of the subject matter described in this specification can be implemented so as to realize one or more of the following advantages. Demographic information regarding the user is important for providing users with personalized online experiences, e.g., by providing specific digital components that are relevant to the users. In general data used to provide a personalized online experience has been aggregated through the use of third party cookies (e.g., cookies that belong to a domain that differs from the domain the client device is visiting), which allows the linking of browsing activity and other behavioral and/or identifying user trace data across time, sessions, and devices. However, an increasing proportion of web traffic does not allow for the use of third-party cookies, either due to users' privacy preferences, lack of browser support for third-party cookies, or other degradation thereby eliminating the possibility of using third party cookies to aggregate data from multiple different sources. To solve the problem of aggregating data from multiple different sources without using (or the availability of) third party cookies, machine learning models can be trained to predict information that would have otherwise been aggregated from multiple different sources using third party cookies. As discussed in detail throughout this document, the machine learning models can be trained in a manner that increases user privacy relative to the use of third party cookies. As such, the use of machine learning models can provide improvements related to data access as well as providing a solution to a data aggregation problem caused by blocking of third party cookies by browsers. Implementing such methods require training the machine learning models over datasets acquired from real world users. Machine learning models are capable of learning complex patterns of the training dataset, thereby reducing errors in predictions regarding the user characteristics. Such implementations allow delivery of finely selected digital components based on predicted user characteristics (e.g., demographic information), thereby improving the user experience while maintaining user privacy.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are distributed.

FIG. 2 is a block diagram of an example machine learning model implemented by the user evaluation apparatus.

FIG. 3 is a flow diagram of an example process of distribution digital components using a machine learning model.

FIG. 4 is a block diagram of an example computer system that can be used to perform operations described.

### DETAILED DESCRIPTION

This document discloses methods, systems, apparatus, and computer readable media that implement machine learning models capable of predicting information that would have been collected using third party cookies, without the use of third party cookies, and while maintaining user privacy. In some situations, the output of the machine learning models can be used to select and distribute digital components to users, thereby providing a personalized online experience.

In general, users connected to the internet via client devices can be provided with digital components. In such scenarios, the digital component provider may wish to provide digital components based on data aggregated from multiple different sources, such as the users' online activity and users' browsing history. However, more and more users opting out of allowing aggregation of certain information that has previously been collected and used, and third party cookies are being blocked by some browsers, such that digital component selection must be performed without the use of third party cookies (e.g., cookies from a domain that differs from the domain of the web page currently being viewed by a user). As such, a solution is needed for aggregating data that is capable of being used to provide a personalized online experience when third party cookies cannot be used.

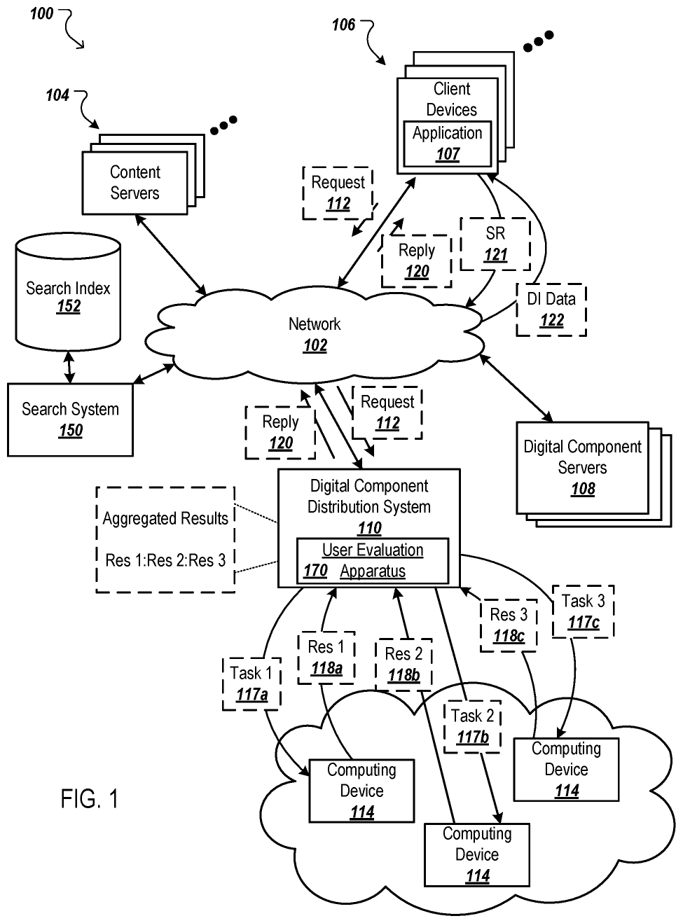

New techniques have emerged that distribute digital components to users, by assigning the users to user groups when the users visit particular resources or perform particular actions at the resource (e.g., interact with a particular item presented on a web page or add the item to a virtual cart). These user groups are generally created in a manner such that each user group includes a sufficient number of users, such that no individual user can be identified. User characteristics, such as demographic information regarding the user, still remains important for providing users with personalized online experiences, e.g., by providing specific digital components that are relevant to the users. However, due to unavailability of such information, personalization of the content can be difficult. A solution is therefore needed for predicting such user information and/or characteristics. The techniques and methods are further explained with reference to FIG. 1-4.

FIG. 1 is a block diagram of an example environment 100 in which digital components are distributed for presentation with electronic documents. The example environment 100 includes a network 102, such as a local area network (LAN), a wide area network (WAN), the Internet, or a combination thereof. The network 102 connects content servers 104, client devices 106, digital component servers 108, and a digital component distribution system 110 (also referred to as a component distribution system (CDS)).

A client device 106 is an electronic device that is capable of requesting and receiving resources over the network 102. Example client devices 106 include personal computers, mobile communication devices, wearable devices, personal digital assistants, and other devices that can send and receive data over the network 102. A client device 106 typically includes a user application 112, such as a web browser, to facilitate the sending and receiving of data over the network 102, but native applications executed by the client device 106 can also facilitate the sending and receiving of data over the network 102. Client devices 106, and in particular personal digital assistants, can include hardware and/or software that enable voice interaction with the client devices 106. For example, the client devices 106 can include a microphone through which users can submit audio (e.g., voice) input, such as commands, search queries, browsing instructions, smart home instructions, and/or other information. Additionally, the client devices 106 can include speakers through which users can be provided audio (e.g., voice) output. A personal digital assistant can be implemented in any client device 106, with examples including wearables, a smart speaker, home appliances, cars, tablet devices, or other client devices 106.

An electronic document is data that presents a set of content at a client device 106. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to client devices 106 by content servers 104. For example, the content servers 104 can include servers that host publisher websites. In this example, the client device 106 can initiate a request for a given publisher webpage, and the content server 104 that hosts the given publisher web page can respond to the request by sending machine executable instructions that initiate presentation of the given webpage at the client device 106.

In another example, the content servers 104 can include app-servers from which client devices 106 can download apps. In this example, the client device 106 can download files required to install an app at the client device 106, and then execute the downloaded app locally. The downloaded app can be configured to present a combination of native content that is part of the application itself, as well as one or more digital components (e.g., content created/distributed by a third party) that are obtained from a digital component server 108, and inserted into the app while the app is being executed at the client device 106.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a tag or script that causes the client device 106 to request content from the data source when the given electronic document is processed (e.g., rendered or executed) by a client device 106. The client device 106 integrates the content obtained from the data source into the given electronic document to create a composite electronic document including the content obtained from the data source.

In some situations, a given electronic document can include a digital component tag or digital component script that references the digital component distribution system 110. In these situations, the digital component tag or the digital component script is executed by the client device 106 when the given electronic document is processed by the client device 106. Execution of the digital component tag or digital component script configures the client device 106 to generate a request for digital components 112 (referred to as a “component request”), which is transmitted over the network 102 to the digital component distribution system 110. For example, the digital component tag or digital component script can enable the client device 106 to generate a packetized data request including a header and payload data. The digital component request 112 can include event data specifying features such as a name (or network location) of a server from which media is being requested, a name (or network location) of the requesting device (e.g., the client device 106), and/or information that the digital component distribution system 110 can use to select one or more digital components provided in response to the request. The component request 112 is transmitted, by the client device 106, over the network 102 (e.g., a telecommunications network) to a server of the digital component distribution system 110.

The digital component request 112 can include event data specifying other event features, such as the electronic document being requested and characteristics of locations of the electronic document at which digital component can be presented. For example, event data specifying a reference (e.g., Uniform Resource Locator (URL)) to an electronic document (e.g., webpage or application) in which the digital component will be presented, available locations of the electronic documents that are available to present digital component, sizes of the available locations, and/or media types that are eligible for presentation in the locations can be provided to the digital component distribution system 110. Similarly, event data specifying keywords associated with the electronic document (“document keywords”) or entities (e.g., people, places, or things) that are referenced by the electronic document can also be included in the component request 112 (e.g., as payload data) and provided to the digital component distribution system 110 to facilitate identification of digital component that are eligible for presentation with the electronic document. The event data can also include a search query that was submitted from the client device 106 to obtain a search results page and/or data specifying search results and/or textual, audible, or other visual content that is included in the search results.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The digital component distribution system 110, which includes one or more digital component distribution servers, chooses digital components that will be presented with the given electronic document in response to receiving the component request 112 and/or using information included in the component request 112. In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106. Also, as the delay in providing the digital component to the client device 106 increases, it is more likely that the electronic document will no longer be presented at the client device 106 when the digital component is delivered to the client device 106, thereby negatively impacting a user's experience with the electronic document as well as wasting system bandwidth and other resources. Further, delays in providing the digital component can result in a failed delivery of the digital component, for example, if the electronic document is no longer presented at the client device 106 when the digital component is provided.

To facilitate searching of electronic documents, the environment 100 can include a search system 150 that identifies the electronic documents by crawling and indexing the electronic documents (e.g., indexed based on the crawled content of the electronic documents). Data about the electronic documents can be indexed based on the electronic document with which the data are associated. The indexed and, optionally, cached copies of the electronic documents are stored in a search index 152 (e.g., hardware memory device(s)). Data that are associated with an electronic document is data that represents content included in the electronic document and/or metadata for the electronic document.

Client devices 106 can submit search queries to the search system 150 over the network 102. In response, the search system 150 accesses the search index 152 to identify electronic documents that are relevant to the search query. The search system 150 identifies the electronic documents in the form of search results and returns the search results to the client device 106 in search results page. A search result is data generated by the search system 150 that identifies an electronic document that is responsive (e.g., relevant) to a particular search query, and includes an active link (e.g., hypertext link) that causes a client device to request data from a specified location in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 106. Another example search result can include a title of streaming media, a snippet of text describing the streaming media, an image depicting contents of the streaming media, and/or a URL to a location from which the streaming media can be downloaded to the client device 106. Like other electronic documents search results pages can include one or more slots in which digital components (e.g., advertisements, video clips, audio clips, images, or other digital components) can be presented.

In some implementations, the digital component distribution system 110 is implemented in a distributed computing system that includes, for example, a server and a set of multiple computing devices 114 that are interconnected and identify and distribute digital components in response to component requests 112. The set of multiple computing devices 114 operate together to identify a set of digital components that are eligible to be presented in the electronic document from among a corpus of millions of available digital components.

In some implementations, the digital component distribution system 110 implements different techniques for selecting and distributing digital components. For example, digital components can include corresponding distribution parameters that contribute to (e.g., condition or limit) the selection/distribution/transmission of the corresponding digital component. For example, the distribution parameters can contribute to the transmission of a digital component by requiring that a component request include at least one criterion that matches (e.g., either exactly or with some pre-specified level of similarity) one of the distribution parameters of the digital component.

In another example, the distribution parameters for a particular digital component can include distribution keywords that must be matched (e.g., by electronic documents, document keywords, or terms specified in the component request 112) in order for the digital components to be eligible for presentation. The distribution parameters can also require that the component request 112 include information specifying a particular geographic region (e.g., country or state) and/or information specifying that the component request 112 originated at a particular type of client device 106 (e.g., mobile device or tablet device) in order for the component item to be eligible for presentation. The distribution parameters can also specify an eligibility value (e.g., rank, score or some other specified value) that is used for evaluating the eligibility of the component item for selection/distribution/transmission (e.g., among other available digital components), as discussed in more detail below. In some situations, the eligibility value can be based on an amount that will be submitted when a specific event is attributed to the digital component item (e.g., presentation of the digital component).

The identification of the eligible digital components can be segmented into multiple tasks 117a-117c that are then assigned among computing devices within the set of multiple computing devices 114. For example, different computing devices in the set 114 can each analyze a different digital component to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the digital component distribution system 110. For example, the results 118a-118c provided by each of the computing devices in the set 114 may identify a subset of digital component items that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The digital component distribution system 110 aggregates the results 118a-118c received from the set of multiple computing devices 114 and uses information associated with the aggregated results to select one or more digital components that will be provided in response to the component request 112. For example, the digital component distribution system 110 can select a set of winning digital components (one or more digital components) based on the outcome of one or more digital component evaluation processes. In turn, the digital component distribution system 110 can generate and transmit, over the network 102, reply data 120 (e.g., digital data representing a reply) that enable the client device 106 to integrate the set of winning digital component into the given electronic document, such that the set of winning digital components and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the server request 121, the digital component server 108 will identify the given winning digital component specified in the server request 121 and transmit, to the client device 106, digital component data 122 (DI Data) that presents the given winning digital component in the electronic document at the client device 106.

In some situations, distribution parameters for digital component distribution may include user characteristics such as demographic information, user interests, and/or other information that can be used to personalize the user's online experience. In some situations, these characteristics and/or information regarding the user of the client device 106 is readily available. For example, content platforms such as the content server 104 or the search system 150 may allow the user to register with the content platform by providing such user information. In another example, the content platform can use cookies to identify client devices, which can store information about the user's online activity and/or user characteristics. Historically, third party cookies have been used to provide user characteristics to the digital component distribution system 110 irrespective of what domain the user was visiting. However, these and other methods of identifying user characteristics are becoming less prevalent in an effort to protect user privacy. For example, browsers have been redesigned to actively block the use of third party cookies, thereby preventing the digital component distribution system 110 from accessing user characteristics unless the user is accessing a resource that is in the same domain as the digital component distribution system 110.

To protect user privacy while still being able to ascertain some characteristics of users, the users can be assigned to user groups based on the digital content accessed by the user during a single browsing session. For example, when a user visits a particular website and interacts with a particular item presented on the website or adds an item to a virtual cart, the user can be assigned to a group of users who have visited the same website or other websites that are contextually similar or are interested in the same item. To illustrate, if the user of the client device 106 searches for shoes and visits multiple webpages of different shoe manufacturers, the user can be assigned to the user group “shoe,” which can include identifiers for all users who have visited websites related to shoes. Thus, the user groups can represent interests of the users in the aggregate without identifying the individual users and without enabling any individual user to be identified. For example, the user groups can be identified by a user group identifier that is used for every user in the group. As an example, if a user adds shoes to a shopping cart of an online retailer, the user can be added to a shoes user group having a particular identifier, which is used for every user in the group. When a device of any user in the shoes user group submits a request for content, that same particular identifier can be submitted such that every user in that same group submits the same particular identifier.

In some implementations, a user's group membership can be maintained at the user's client device 106, e.g., by a browser based application, rather than by a digital component provider or by a content platform, or by another party. The user groups can be specified by a respective user group identifier. The user group identifier for a user group can be descriptive of the group (e.g., gardening group) or a code that represents the group (e.g., an alphanumeric sequence that is not descriptive).

In some implementations, the assignment of a user to a user group is a temporary assignment since the user's group membership can change with respect to the user's browsing activity. For example, when the users starts a web browsing session and visits particular website and interacts with a particular item presented on the website or adds an item to a virtual cart, the user can be assigned to a group of users who have visited the same website or other websites that are contextually similar or are interested in the same item. However if the user visits another website and interacts with another type of item presented on the other website, the user is assigned to another group of users who have visited the other website or other websites that are contextually similar or are interested in the other item. For example, if the user starts the browsing session by searching for shoes and visiting multiple webpages of different shoe manufacturers, the user can be assigned to the user group “shoe,” which includes all users who have visited websites related to shoes. Assume that there are 100 users who have previously visited websites related to shoes. When the user is assigned to the user group “shoe”, the total number of users included in the user group increases to 101. However after sometime if the user searches for hotels and visits multiple webpages of different hotels or travel agencies, the user can be removed from the previously assigned user group “shoe” and re-assigned to a different user group “hotel” or “travel”. In such a case, the number of users in the user group “shoe”, reduces back to 100 given that no other user was added or removed from the particular user group.

Because of the temporary nature of the user group assignment, the user groups are sometimes referred to as temporary user groups and the corresponding user group identifiers as temporary group identifiers.

In some implementations, there can be one or more user groups that are contextually similar but differ in one or more characteristics. For example, two users based on their respective browsing activity can be assigned user groups “travel-location1” and “travel-location2” respectively where both the user groups are contextually similar suggesting that both users probably have an intention of travelling but to different locations.

In some implementations, the number and types of user groups is managed and/or controlled by a system (or administrator). For example, the system may implement an algorithmic and/or machine learning method to oversee the management of the user groups. In general, since the flux of users who are engaged in an active browser session changes with time and since each individual user is responsible for their respective browsing activity, the number of user groups and number of users in each of the user groups changes with time. This method can be applied in such a way as to provide provable guarantees of privacy or non-identifiability of the individuals within each user group.

In situations where user characteristics are not available, for example because third party cookies are blocked, the digital component distribution system 110 can include a user evaluation apparatus 170 that predicts information that could have aggregated using third party cookies, such as user characteristics, based on available information. In some implementations, the user evaluation apparatus 170 implements one or more machine learning models that predict one or more user characteristics based on information included in the component request 112 (e.g., group identifier).

For example, if a user of the client device 106 uses a browser based application 107 to load a website that includes one or more digital component slots, the browser based application 107 can generate and transmit a component request 112 for each of the one or more digital component slots. The component request 112 includes the user group identifier corresponding to the user group that includes an identifier for the client device 106, other information (also referred to as additional information) such as geographic information indicating a state or region from which the component request 112 was submitted, or other information that provides context for the environment in which the digital component 112 will be displayed (e.g., a time of day of the component request, a day of the week of the component request, a type of client device 106 at which the digital component will be displayed, such as a mobile device or tablet device). Some of this information is obtained from settings of the client device 106, such as language settings, time zone settings, client MAC address, etc. that are included in the component request 112. Other information can be derived from other information included in the component request 112, such as an IP address, which can be used to infer a geographic region of the client device 106.

In some implementations, the component request 112 may also include information (also referred to as activity features) regarding the browsing activity of the user and/or of similar users within the users' assigned group. For example, a list of URLs accessed by the user using the client device 106 or a subset of the list of URLs most frequently accessed by the user in a particular browsing session.

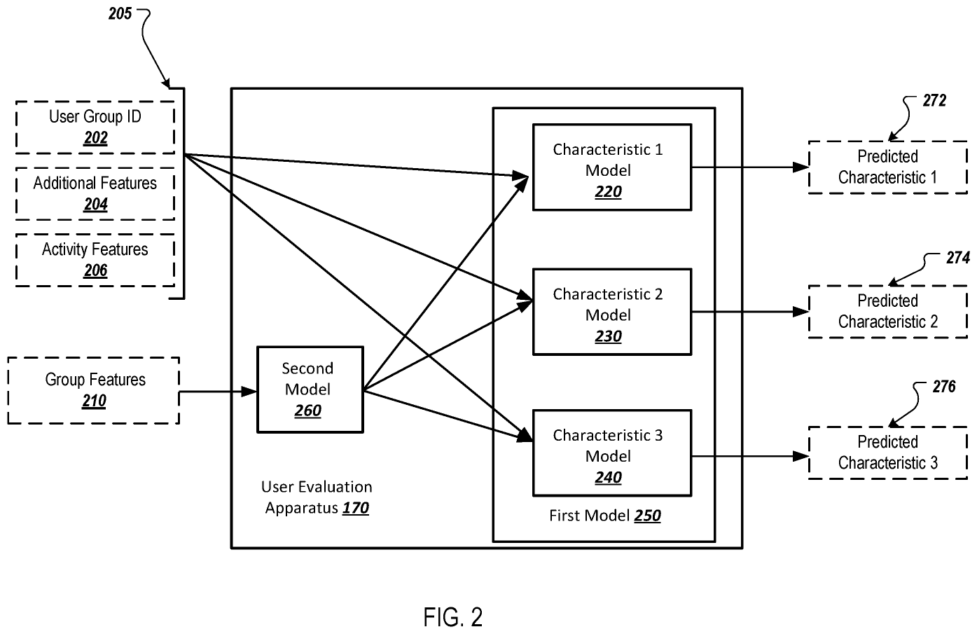

The digital component distribution system 110, after receiving the component request 112, provides the information included in the component request 112 as input to the machine learning model. The machine learning model, after processing the input, generates an output including a prediction of one or more user characteristics that were not included in the component request 112. These one or more user characteristics along with other information included in the component request 112 can be used to fetch digital components from the digital component server 108. Generating the predicted output of user characteristics is further explained with reference to FIG. 2.

FIG. 2 is a block diagram of an example machine learning model implemented within the user evaluation apparatus 170. In general, a machine learning model can be any technique deemed suitable for the specific implementation, such as an artificial neural network (ANN), support vector machines (SVM), random forests (RF) etc., that includes multiple trainable parameters. During the training process, the multiple training parameters are adjusted while iterating over the multiple samples of the training dataset (a process referred to as optimization) based on the error generated by the loss function. The loss function compares the predicted values of the machine learning model against the true value of the samples in the training set to generate a measure of prediction error.

In some implementations, the user evaluation apparatus 170 can implement multiple machine learning models (e.g. a first model 250 and a second model 260) such that the first model 250 predicts user characteristics (e.g., user demographic characteristic, user interest, or some other characteristic) and the second model 260 provides a data representation for input to the first model 250 by processing information related to the user group.

The first model 250 may include multiple sub-machine learning models (also referred to as “sub-models”) such that each sub-model predicts a particular user characteristic (e.g., user demographic characteristic, user interest, or some other characteristic). For example, the first model 250 includes three sub-models: (i) characteristic 1 model 220, (ii) characteristic 2 model 230 and (iii) characteristic 3 model 240. Each of these sub-models predicts the likelihood that a user has a different characteristic (e.g., demographic characteristic or user interest). Other implementations may include more or fewer individual sub-models to predict a system (or administrator) defined number of user characteristics. In effect, the sub-models and the second model 260 of the user evaluation apparatus 170 aggregate the input data such as user group ID 202, additional features 204, activity features 206 and group features 210 to form user characteristics.

The machine learning model can accept as inputs, information included in the component request 112. As mentioned before, the component request 112 can include the user group identifier corresponding to the user group that includes the client device 106, along with various signals derived from this group identifier such as the average characteristics or aggregate behavioral statistics of users within the group, and/or other information (also referred to as additional features) such as geographic information indicating a state or region from which the component request 112 was submitted, or other information that provides context for the environment in which the digital component 112 will be displayed (e.g., a time of day of the component request, a day of the week of the component request, a type of client device 106 at which the digital component will be displayed, such as a mobile device or tablet device). For example, the input 205 includes information that was included in the component request 112, i.e., the user group identifier (User Group ID) 202 and the set of additional features 204.

In some implementations, the machine learning models (and/or the sub-models) implemented within the user evaluation apparatus 170, can accept activity features 206 related to the user's current online activity. The activity features 206 can include a list of websites previously accessed by the user in the current session, prior interactions with digital components presented in previously accessed websites. For example, a list of URLs linked to the websites visited by the user of the client device 106. Depending on the particular implementations, the set of activity features 206 can be maintained by the content provider (or a digital component provider) or can be provided by the client device 106 by including the set of activity features 206 within the component request 112.

In some implementations, the activity features 206 may include features based on the websites accessed by the user. In one scenario, websites can be individually classified into categories based on the content of the websites. For example, each website can be classified into categories such as “sports”, “news”, “e-commerce” etc. In such an implementation, categories of websites linked to the URLs in the list of URLs can be provided as input to the machine learning models (or the sub-models). In another scenario, websites can be assigned one or more labels based on the content of the websites. For example, the content of the websites can be analyzed using topic modelling techniques and labelled accordingly. In such implementations, the labels associated with websites linked to the URLs in the list of URLs can be provided as input to the machine learning models (or the sub-models). In another scenario, the websites can be clustered together based on one or more properties (e.g., labels, topics, keywords that are associated with each website) such that each website has an associated weight representing the strength of belonging to one or more clusters. These weights can be provided as input to the machine learning models (or the sub-models).

The machine learning models (or the sub-models) implemented within the user evaluation apparatus 170, can accept features related to the user group to which the user of the client device 106 is a member. The user evaluation apparatus 170 uses the set of group features 210 as input. In some implementations, the group features 210 can be maintained by the content provider (or the digital component provider). For example, the digital component provider and/or server 108 can maintain and update multiple features (also referred to as parameters) of all user groups at regular intervals based on all active users in all user groups and prior predictions for users in all groups. The set of group features 210 may include information such as the number of users in the group, an aggregate of user demographics in the user group, average predictions of user characteristics of the user group, a list of websites (or URLs) that are frequently visited by users of the user group, or a similarity of digital content accessed by the users of the user group (e.g., the similarity of the web content of the websites accessed by the users) etc.

Depending on the particular implementation, the machine learning model (and/or the sub-models) can use one or more of the input features to generate an output including a prediction of user characteristics. For example, the characteristic 1 model 220 may predict, as output, the predicted characteristic 1 272 (e.g., predicted gender) of the user of the client device 106. Similarly, the characteristic 2 model 230 may be a regression model that processes the inputs 205 and 210 and generates, as output, the predicted characteristic 2 274 (e.g., predicted age range) of the user of the client device 106. In the same way, the characteristic model 3 240 generates, as output, a predicted characteristic 3 of the user.

These predicted user characteristics along with the input features 205 and 210 are used to select digital components provided by the digital component provider and/or server 108. However implementing one or more machine learning models (e.g., the first model 250 and the second model 260) and the sub-models (e.g., the characteristic 1 model 220, the characteristic 2 model 230 and the characteristic 3 model 240) by the user evaluation apparatus 170 to predict user characteristics requires training the machine learning models.

Depending upon the architecture of the machine learning model (or each of the sub-models) the training process may be different based on the individual learning objective of each model or same based on an overall learning objective. For example, in this particular example, the learning objective of the second model 260 is to process the set of group features 210 and generate as output an intermediate representation that embeds information provided by the set of group features 210. Similarly, the learning objective of each of the sub-models 220, 230 and 240 implemented within the first model 250 is to process the output of the second model 260 along with user group ID 202, additional features 204 and the activity features 206 to generate an output which includes the predicted user characteristics 272, 274 and 276 respectively. Depending on the specific implementation, the training process of the machine learning models can be supervised, unsupervised, or semi-supervised and may also include adjusting multiple hyper-parameters associated with the model (process referred to as hyper-parameter tuning).

In general, training a machine learning model requires a training dataset that includes multiple training samples. A training dataset for a machine learning model that performs classification includes features and ground truth labels that are acquired from the real world. There are many techniques of acquiring real world data for the training dataset. For example, data can be gathered using user surveys or from users who voluntarily provide access to information related to their online browsing. In another example, content platforms such as the content server 104 or the search system 150 may allow the user to register with the content platform by providing user information. In another example, the content platform can use cookies to identify client devices, which can store information about the user's online activity and/or user characteristics.

In some implementations, each sample of the training dataset related to an user includes an anonymous user identifier (an identifier that does not allow identification of the user. e.g., index of the samples of the training dataset), the user group identifier (User Group ID) 202 to which the anonymous user is associated to, a subset of features from the set of additional features 204, the set of activity features 206, the set of group features 210 and one or more known user characteristics (ground truth labels) of the anonymous user. In some implementations, each sample of the training dataset may also include one or more URLs accessed by the anonymous user.

The set of group features 210 may include one or more aggregate user group demographics features that collectively characterizes the users in the particular group. The aggregate user group demographics features generally provides collective information of all users in a user group and does not allow identification of a particular user in the user group thereby maintaining user privacy. Examples of such aggregate user group demographic features include the total number of users in a user group, the gender ratio of users in the user group, the web content (such as URLs or domains) most frequently visited by members of a group, features associated with the content of pages most frequently visited by members of a group, and other signals derived from aggregations of the behavior or true/inferred characteristics of members of the group. As mentioned previously, during the training process such information (e.g., gender) about users in a user group are available in the training dataset (for e.g., via cookies). However, when the system is online such information is not available. In such a scenario, such aggregate user group demographics features are observed from the training dataset and provided as input to the machine learning models. For example, assume that the male to female ratio of users in a particular user group is 2/3 as reflected in the training dataset. The system assumes that the ratio is maintained and uses the same male to female ratio as one of the features in the set of group features 210 while predicting user characteristics and selecting digital components for the user.

In some implementations, the set of group features 210 may include an aggregate of one or more context predictions. The aggregate of context prediction is an aggregated result of prior true or predicted user characteristics of the users in a particular user group based on the digital content accessed by the users. For example, assume that for each of the past N similar component requests from same or different users from the same user group, the machine learning models implemented within the user evaluation apparatus 170 generates user characteristics as predictions. In such a scenario, the system may include the aggregate of all N predicted user characteristics as a feature in the set of group features 210.

In some implementations, the set of group features 210 may include a list of URLs accessed by the users of the same user group. For example, such a list may include either the most frequently visited URLs or the complete list of URLs accessed by users of the user group. In some implementations, the set of group features may include a measure of similarity of web content accessed by the users in the user group. In such implementations, digital content (content of the website) can be analyzed to calculate a semantic similarity among the contents of the websites. For example, assume that the users of a particular user group frequently visit 25 websites. A Latent Dirichlet Allocation (LDA) model can be implemented to capture the distribution of topics among the contents of the 25 websites. In general the LDA model generates a vectorized representation of the contents of each website that can be used to calculate the similarity (e.g., cosine similarity) of the websites. Other methods of calculating such similarities may include techniques like Jaccard Similarity, Latent Semantic Analysis (LSA), Non Negative Matrix Factorization and different embedding techniques. These features may be based on directly observable characteristics of user behavior, or they may be derived from the output of other machine learning models, e.g. a model which provides a representation of the plurality of URLs accessed by users of the same user group. Examples of such representations may include embeddings of URLs, bag-of-URLs or one hot encoding of URLs.

Depending upon the architecture of the evaluation apparatus 170, after receiving a component request 112 for a digital component, a machine learning model (e.g., the second model 260) may analyze digital content accessed by other users of user group and the user of the client device 106 belonging to the same user group to calculate a semantic similarity among the digital contents accessed. In such implementations, the output of such a similarity check can be a score, a likelihood or a data representation that provides certain information to other models implemented within the evaluation apparatus 170.

Once the machine learning model (or sub-models) is trained, the digital component distribution system 110 can select digital components based on the one or more user characteristics predicted by the user evaluation apparatus 170 (or the machine learning model implemented within the user evaluation apparatus 170). For example, assume that a male user belonging to the subgroup “shoe”, provides a search query “slippers” through the client device 106 to obtain a search results page and/or data specifying search results and/or textual, audible, or other visual content that is related to the search query. Assume that the search results page includes a slot for digital components provided by entities other than the entity that generates and provides the search results page. The browser based application 107 executing on the client device 106 generates a component request 112 for the digital component slot. The digital component distribution system 110, after receiving the component request 112, provides the information included in the component request 112 as input to the machine learning model that is implemented by the user evaluation apparatus 170. The machine learning model generates, as output, a prediction of one or more user characteristics. For example, the sub-machine learning model 220 correctly predicts the user of the client device 106 as a male, based on the learned parameters. The digital component provider 110 can therefore select digital components related to slippers that are specified for distribution to males. After selection, the selected digital components are transmitted to the client device 106 for presentation along with the search results in the search results page.

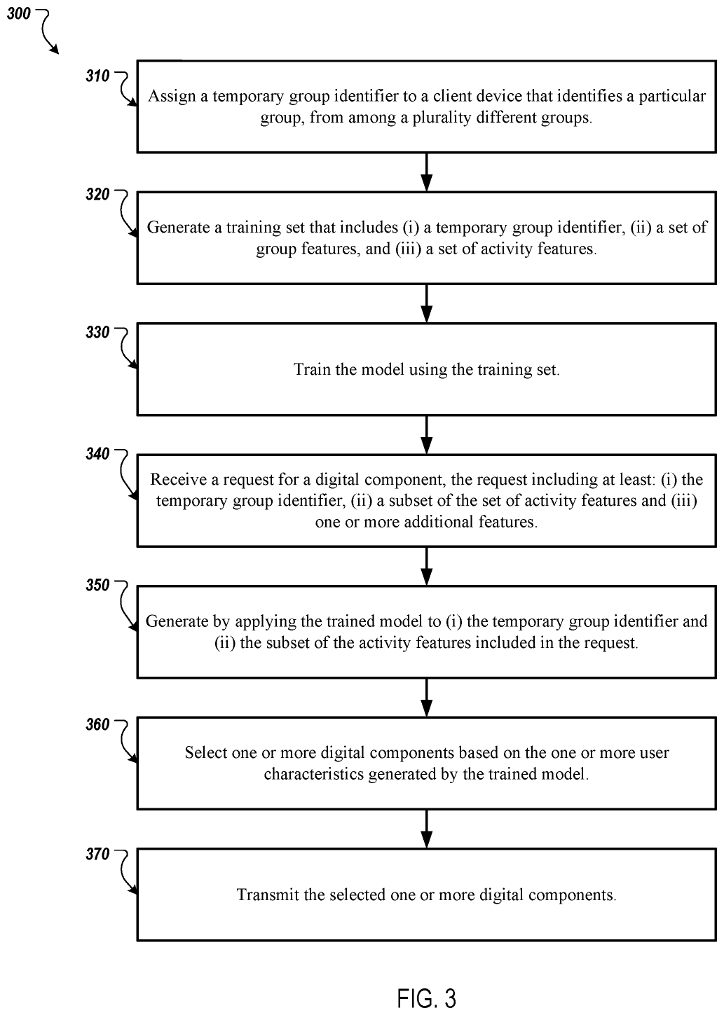

FIG. 3 is a flow diagram of an example process 300 of distributing digital components using machine learning models. Operations of process 300 are described below as being performed by the components of the system described and depicted in FIGS. 1 and 2. Operations of the process 300 are described below for illustration purposes only. Operations of the process 300 can be performed by any appropriate device or system, e.g., any appropriate data processing apparatus. Operations of the process 300 can also be implemented as instructions stored on a non-transitory computer readable medium. Execution of the instructions causes one or more data processing apparatus to perform operations of the process 300.

A client device is assigned a temporary group identifier that identifies a particular group, from among a plurality different groups (310). In some implementations and as described with reference to FIG. 1, the users can be assigned to user groups based on the digital content accessed by the user during a single browsing session. For example, when the user visits a particular website and interacts with a particular item presented on the website or adds an item to a virtual cart, the user can be assigned to a group of users who have visited the same website or other websites that are contextually similar or are interested in the same item. For example, if the user of the client device 106 searches for shoes and visits multiple webpages of different shoe manufacturers, the user can be assigned to the user group “shoe,” which can include identifiers for all users who have visited websites related to shoes. Thus, the user groups can represent interests of the users in the aggregate without identifying the individual users and without enabling any individual user to be identified. For example, the user groups can be identified by a user group identifier that is used for every user in the group. As an example, if a user adds shoes to a shopping cart of an online retailer, the user can be added to a shoes user group having a particular identifier, which is used for every user in the group.

A training set is generated that includes a temporary group identifier, a set of group features, and a set of activity features (320). In some implementations, each sample of the training dataset related to an user includes an anonymous user identifier (an identifier that does not allow identification of the user. e.g., index of the samples of the training dataset), the user group identifier (User Group ID) 202 to which the anonymous user is associated to, a subset of features from the set of additional features 204, the set of activity features 206, the set of group features 210 and one or more true user characteristics (ground truth labels) of the anonymous user. In some implementations, each sample of the training dataset may also include one or more URLs accessed by the anonymous user.

The set of additional features is generally included within the component request 112. It includes information such as the geographic information indicating a state or region from which the component request 112 was submitted, or other information that provides context for the environment in which the digital component 112 will be displayed (e.g., a time of day of the component request, a day of the week of the component request, a type of client device 106 at which the digital component will be displayed, such as a mobile device or tablet device).

The set of activity features 206 can include a list of websites previously accessed by the user in the current session, prior interactions with digital components presented in previously accessed websites. For example, a list of URLs linked to the websites visited by the user of the client device 106. Depending on the particular implementations, the set of activity features 206 can be maintained by the content provider (or a digital component provider) or can be provided by the client device 106 by including the set of activity features 206 within the component request 112.

The set of group features 210 can be maintained by the content provider (or the digital component provider). For example, the digital component provider and/or server 108 can maintain and update multiple features (also referred to as parameters) of all user groups at regular intervals based on all active users in all user groups and prior predictions for users in all groups. The set of group features 210 may include information such as the number of users in the group, an aggregate of user demographics in the user group, average predictions of user characteristics of the user group, a list of websites (or URLs) that are frequently visited by users of the user group, or a similarity of digital content accessed by the users of the user group (e.g., the similarity of the web content of the websites accessed by the users) etc.

The model is trained using the training set (330). For example, the machine learning models implemented within the user evaluation apparatus 170 are trained on the training dataset. Depending on the specific implementation, the training process of the sub-machine learning model can be supervised, unsupervised, or semi-supervised and may also include adjusting multiple hyper-parameters associated with the model (process referred to as hyper-parameter tuning). During the training process, the multiple training parameters are adjusted while iterating over the multiple samples of the training dataset (a process referred to as optimization) based on the error generated by the loss function which compares the predicted values of the machine learning model and the true value of the samples in the training set.

The training process depends upon the architecture of the machine learning model (or each of the sub-models). For example, the training process may be different based on the individual learning objective of each model or same based on an overall learning objective. For example, and with reference to FIG. 2, the learning objective of the second model 260 is to process the set of group features 210 and generate as output an intermediate representation that embeds information provided by the set of group features 210. Similarly, the learning objective of each of the sub-models 220, 230 and 240 implemented within the first model 250 is to process the output of the second model 260 along with user group ID 202, additional features 204 and the activity features 206 to generate an output which includes the predicted user characteristics 272, 274 and 276 respectively.

A request for a digital component is received (340). For example, if a user of the client device 106 uses a browser based application 107 to load a website that includes one or more digital component slots, the browser based application 107 can generate and transmit a component request 112 for each of the one or more digital component slots. In some implementations, the component request 112 includes the user group identifier (User Group ID) 202 corresponding to the user group that includes an identifier for the client device 106, other information (also referred to as additional features 204) such as geographic information indicating a state or region from which the component request 112 was submitted, or other information that provides context for the environment in which the digital component 112 will be displayed (e.g., a time of day of the component request, a day of the week of the component request, a type of client device 106 at which the digital component will be displayed, such as a mobile device or tablet device). In some implementations, the component request 112 may also include information (also referred to as activity features 206) regarding the browsing activity of the user. For example, a list of URLs accessed by the user using the client device 106 or a subset of the list of URLs most frequently accessed by the user in a particular browsing session.

The trained model is applied to information included in the request to generate one or more user characteristics that are not included in the request (350). In some implementations, the machine learning model (and/or the sub-models) implemented within the user evaluation apparatus 170 can use one or more of the input features to generate an output including a prediction of user characteristics. For example, the characteristic 1 model 220 may predict, as output, the predicted characteristic 1 272 (e.g., predicted gender) of the user of the client device 106. Similarly, the characteristic 2 model 230 may be regression model that processes the inputs 205 and 210 and generates, as output, the predicted characteristic 2 274 (e.g., predicted age range) of the user of the client device 106. In the same way, the characteristic model 3 240 generates, as output, a predicted characteristic 3 of the user.

In some implementations, the input features may include the user group identifier (User Group ID) 202, a subset of features from the set of additional features 204, the set of activity features 206 and the set of group features 210.

One or more digital components are selected based on the one or more user characteristics generated by the trained model. (360). For example, assume that a male user belonging to the subgroup “shoes”, provides a search query “slippers” through the client device 106 to obtain a search results page and/or data specifying search results and/or textual, audible, or other visual content that is related to the search query. Assume that the search results page includes a slot for digital components. The browser based application 107 executing on the client device 106 generates a component request 112 for the digital component slot. The digital component distribution system 110, after receiving the component request 112, provides the information included in the component request 112 as input to the machine learning model that is implemented by the user evaluation apparatus 170. The machine learning model, after processing the input, generates as output a prediction of one or more user characteristics. For example, the sub-machine learning model 220 correctly predicts the user of the client device 106 as a male based on the learned parameters. The digital component provider 110 can therefore select digital components related to slippers that have distribution criteria indicating that the digital components should be distributed to males.

The selected one or more digital components are transmitted to the client device (370). For example, after selecting the digital components based on the predicted user characteristics by the digital component distribution system 110, the selected digital components are transmitted to the client device 106 for presentation.

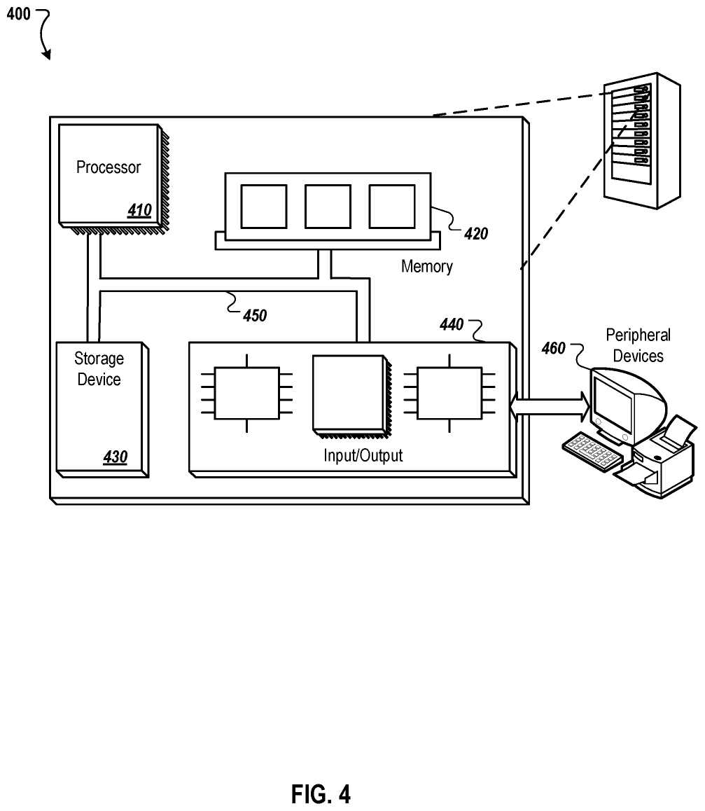

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 370. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
assigning, to a client device, a temporary group identifier that identifies a particular group, from among a plurality different groups, that includes the client device based on a current period of user activity on the client device;
generating, for a model to be trained, a training set including (i) a temporary group identifier assigned to the client device based on a current period of user activity at a client device, (ii) a set of group features of users that have been assigned the temporary group identifier, and (iii) a set of activity features of user activity performed by users that have been assigned the temporary group identifier, wherein the temporary group identifier identifies a particular group, from among a plurality of different groups, that includes the client device;
training the model using the training set;
receiving, from a given client device, a request for a digital component, the request including at least: (i) the temporary group identifier that is currently assigned to the given client device, (ii) a subset of the set of activity features and (iii) one or more additional features wherein the one or more additional features are based on the client device;
generating, by applying the trained model to (i) the temporary group identifier and (ii) the subset of the activity features included in the request, one or more user characteristics that are not included in the request;
selecting one or more digital components based on the one or more user characteristics generated by the trained model; and
transmitting, to the client device, the selected one or more digital components.

2. The method of claim 1, wherein the set of group features comprises: (i) a plurality of uniform resource locators (URLs) that includes a plurality of URLs accessed by users that have been assigned the temporary group identifier, (ii) a representation of the plurality of URLs accessed by users that have been assigned the temporary group identifier.

3. The method of claim 2, wherein the set of group features may further include: (i) a count and/or proportions of the URLs accessed by users that have been assigned the temporary group identifier, (ii) patterns in digital content presented at the URLs accessed by users that have been assigned the temporary group identifier.

4. The method of claim 1, wherein each sample of the training set includes at least: (i) an anonymized identifier of a user that has been assigned the temporary group identifier, (ii) URLs accessed by the user while the user was assigned the temporary group identifier.

5. The method of claim 1, wherein the set of group features comprises one or more aggregate user group demographics collectively characterizing the users in the particular group corresponding to the temporary group identifier without characterizing any individual user in the particular group.

6. The method of claim 1, wherein the set of group features comprises an aggregate context prediction, wherein the aggregate context prediction is a predicted output based on the digital content accessed by users that have been assigned the temporary group identifier.

7. The method of claim 1, wherein the set of activity features includes: (i) a geographic identifier specifying an origin of the request for the digital component, (ii) a time at the origin when the request for the digital component was submitted.

8. A system, comprising:
assigning, to a client device, a temporary group identifier that identifies a particular group, from among a plurality different groups, that includes the client device based on a current period of user activity on the client device;
generating, for a model to be trained, a training set including (i) a temporary group identifier assigned to the client device based on a current period of user activity at a client device, (ii) a set of group features of users that have been assigned the temporary group identifier, and (iii) a set of activity features of user activity performed by users that have been assigned the temporary group identifier, wherein the temporary group identifier identifies a particular group, from among a plurality of different groups, that includes the client device;
training the model using the training set;
receiving, from a given client device, a request for a digital component, the request including at least: (i) the temporary group identifier that is currently assigned to the given client device, (ii) a subset of the set of activity features and (iii) one or more additional features wherein the one or more additional features are based on the client device;
generating, by applying the trained model to (i) the temporary group identifier and (ii) the subset of the activity features included in the request, one or more user characteristics that are not included in the request;
selecting one or more digital components based on the one or more user characteristics generated by the trained model; and
transmitting, to the client device, the selected one or more digital components.

9. The system of claim 8, wherein the set of group features comprises: (i) a plurality of uniform resource locators (URLs) that includes a plurality of URLs accessed by users that have been assigned the temporary group identifier, (ii) a representation of the plurality of URLs accessed by users that have been assigned the temporary group identifier.

10. The system of claim 9, wherein the set of group features may further include: (i) a count and/or proportions of the URLs accessed by users that have been assigned the temporary group identifier, (ii) patterns in digital content presented at the URLs accessed by users that have been assigned the temporary group identifier.

11. The system of claim 8, wherein each sample of the training set includes at least: (i) an anonymized identifier of a user that has been assigned the temporary group identifier, (ii) URLs accessed by the user while the user was assigned the temporary group identifier.

12. The system of claim 8, wherein the set of group features comprises one or more aggregate user group demographics collectively characterizing the users in the particular group corresponding to the temporary group identifier without characterizing any individual user in the particular group.

13. The system of claim 8, wherein the set of group features comprises an aggregate context prediction, wherein the aggregate context prediction is a predicted output based on the digital content accessed by users that have been assigned the temporary group identifier.

14. The system of claim 8, wherein the set of activity features includes: (i) a geographic identifier specifying an origin of the request for the digital component, (ii) a time at the origin when the request for the digital component was submitted.

15. A non-transitory computer readable medium storing instructions that, when executed by one or more data processing apparatus, cause the one or more data processing apparatus to perform operations comprising:
assigning, to a client device, a temporary group identifier that identifies a particular group, from among a plurality different groups, that includes the client device based on a current period of user activity on the client device;
generating, for a model to be trained, a training set including (i) a temporary group identifier assigned to the client device based on a current period of user activity at a client device, (ii) a set of group features of users that have been assigned the temporary group identifier, and (iii) a set of activity features of user activity performed by users that have been assigned the temporary group identifier, wherein the temporary group identifier identifies a particular group, from among a plurality of different groups, that includes the client device;
training the model using the training set;
receiving, from a given client device, a request for a digital component, the request including at least: (i) the temporary group identifier that is currently assigned to the given client device, (ii) a subset of the set of activity features and (iii) one or more additional features wherein the one or more additional features are based on the client device;
generating, by applying the trained model to (i) the temporary group identifier and (ii) the subset of the activity features included in the request, one or more user characteristics that are not included in the request;
selecting one or more digital components based on the one or more user characteristics generated by the trained model; and
transmitting, to the client device, the selected one or more digital components.

16. The non-transitory computer readable medium of claim 15, wherein the set of group features comprises: (i) a plurality of uniform resource locators (URLs) that includes a plurality of URLs accessed by users that have been assigned the temporary group identifier, (ii) a representation of the plurality of URLs accessed by users that have been assigned the temporary group identifier.

17. The non-transitory computer readable medium of claim 16, wherein the set of group features may further include: (i) a count and/or proportions of the URLs accessed by users that have been assigned the temporary group identifier, (ii) patterns in digital content presented at the URLs accessed by users that have been assigned the temporary group identifier.

18. The non-transitory computer readable medium of claim 15, wherein each sample of the training set includes at least: (i) an anonymized identifier of a user that has been assigned the temporary group identifier, (ii) URLs accessed by the user while the user was assigned the temporary group identifier.

19. The non-transitory computer readable medium of claim 15, wherein the set of group features comprises one or more aggregate user group demographics collectively characterizing the users in the particular group corresponding to the temporary group identifier without characterizing any individual user in the particular group.

20. The non-transitory computer readable medium of claim 15, wherein the set of group features comprises an aggregate context prediction, wherein the aggregate context prediction is a predicted output based on the digital content accessed by users that have been assigned the temporary group identifier.
